(19) United States
(12) Patent Application Publication
(10) Pub. No.: US 2013/0179136 A1
(43) Pub. Date: Jul. 11, 2013

(54) SYSTEM AND METHOD FOR SIMULTANEOUS VISUALIZATION OF FLUID FLOW WITHIN WELL COMPLETIONS AND A RESERVOIR

(71) Applicants: Anupam Tiwari, Houston, TX (US); William P. Brown, Houston, TX (US)

(72) Inventors: Anupam Tiwari, Houston, TX (US); William P. Brown, Houston, TX (US)

(21) Appl. No.: 13/811,826

(22) PCT Filed: Jun. 29, 2011
(86) PCT No.: PCT/US11/42406

§ 371 Date: Jan. 23, 2013

Related U.S. Application Data
(60) Provisional application No. 61/381,625, filed on Sep. 10, 2010.

(51) Int. Cl. G06F 17/50

(52) U.S. Cl. CPC G06F 17/5009
USPC 703/10

(57) ABSTRACT

There is provided a system and method for creating a visualization representing location, type and fluid flow in a completion hardware configuration and the fluid flow in a reservoir containing the completion hardware configuration. An exemplary method comprises obtaining data relating to a location and type of the completion hardware configuration. The exemplary method comprises obtaining data relating to fluid flow within the completion hardware configuration based on the location and type of the completion hardware. Data relating to fluid flow within the reservoir is also obtained. The exemplary method also comprises importing the data relating to the location and type of the completion hardware configuration and the fluid flow within the completion hardware configuration into a main program. Data relating to fluid flow within the reservoir is also imported into the main program. The exemplary method comprises providing a visualization that includes the data relating to the location and type of the completion hardware configuration and the fluid flow within the completion hardware configuration, along with the data relating to fluid flow within the reservoir.

### CROSS-REFERENCE TO RELATED APPLICATION

This application claims the benefit of U.S. Provisional Patent Application 61/381,625 filed Sep. 10, 2010 entitled SYSTEM AND METHOD FOR SIMULTANEOUS VISUALIZATION OF FLUID FLOW WITHIN WELL COMPLETIONS AND A RESERVOIR, the entirety of which is incorporated by reference herein.

### FIELD OF THE INVENTION

The present techniques relate to a system and method for providing a physical property model representative of a physical property of a region of interest. In particular, an exemplary embodiment of the present techniques relates to using data from the physical property model to provide a visualization of fluid flow in well completion hardware in conjunction with an associated reservoir.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

The search for hydrocarbon resources takes place in increasingly technically challenging environments. The complexity and cost of wells that extract these hydrocarbons is also increasing. These factors increase the importance of understanding the long-term performance of wells and hydrocarbon fields before investments are made. Computer simulation is a useful tool in assessing various scenarios related to the planning of wells in hydrocarbon fields.

A clear understanding of fluid flow within and outside well completion hardware is important for achieving a safe and optimal depletion of the hydrocarbon reservoir. The fluid flow inside the well completion hardware is affected by the distribution of time-independent properties, like porosity and permeability of reservoir rocks, as well as time-dependent properties, like pressure, in regions near and far from the well. In performing a computer simulation of the fluid flow, the geometry representing the hydrocarbon reservoir is discretized into many small elements called grid-blocks or cells. Likewise, the geometry representing the wellbore and the completion hardware is discretized into many small segments to solve for the fluid flow within them. The overall fluid flow in the reservoir and the completion hardware is obtained by assimilating the information related to flow physics in these grid-blocks and segments. Currently, the detailed modeling and analysis of fluid flow within and outside the well is performed in different software due to the disparate length scales that are involved in the problem. This problem involves multiple length scales because the typical size of a grid-block for solving the fluid flow in a hydrocarbon reservoir is a few hundred feet while the typical element size for segments within the wellbore and completion hardware is a few feet.

There are many known techniques for obtaining detailed flow solutions. The use of different software to analyze different portions of a hydrocarbon-producing environment (for example, reservoir versus completion hardware) makes it challenging and time-consuming to get a comprehensive understanding of the impact of different completion hardware designs on the depletion of the hydrocarbon reservoir.

An analysis of the depletion plan is typically performed by an interdisciplinary team of subsurface and reservoir engineers. For example, a subsurface engineer may be responsible for obtaining the fluid flow solution, at smaller length scales, within the completions. A reservoir engineer may be responsible for obtaining the fluid flow solution, at larger length scales, in the hydrocarbon reservoir. Given the different software used to generate the fluid flow solution and the disparate length scales across which the solution is available, comprehensive visualization and analysis of this information becomes a tedious task.

U.S. Pat. No. 4,210,964 to Rogers, et al. describes a method and apparatus for producing a dynamic display of the response of a petroleum reservoir to a particular recovery process. The disclosed method includes developing a mathematical simulation of the response of the formation and forming a visual display of the simulation for each of a plurality of preset time intervals. A predetermined number of frames of movie film are taken of each display in proper time sequence. The frames of the movie film are then projected to produce a dynamic display of the response of the formation.

U.S. Patent Application Publication No. 20070294034 by Bratton, et al. describes a method for generating a wellsite design. The disclosed method comprises designing a workflow for an Earth Model. The method also includes building an initial Earth Model based on the workflow adapted for modeling drilling and completions operations in a hydrocarbon reservoir. The initial Earth Model is calibrated to generate a calibrated Earth Model. The wellsite design is generated using the calibrated Earth Model.

U.S. Patent Application Publication No. 20060190178 (and also U.S. Pat. No. 7,657,414) by Zamora, et al. describes a visualization system for wellbore and drillstring data that includes a graphics processor for creating a wire mesh model of a well and drillstring based on datasets of depth-varying parameters of the well. A graphics system maps appropriate textures to the wire mesh models which are then displayed on a graphics display. A user interface facilitates user navigation along the length of the well to any selected location therein and further permits user adjustment of orientation of the displayed renderings. The data is sufficient to permit calculation of fluid velocity in the wellbore at any selected location. The fluid velocity is presented as a velocity profile in the rendered visualization of the wellbore and drillstring to provide the user with a visual indication of fluid velocity in the wellbore as the user navigates the visualization along the length of the wellbore and drillstring.

U.S. Pat. No. 6,816,787 to Ramamoorthy, et al. discloses a visualization application to generate a Virtual Core representing a compilation of any formation property data, the compilation being a 2½ dimensional (2½ D) representation of any formation property. The compilation is generated by creating in response to an integrated formation evaluation in 1D a 2½ D representation of each one dimensional (1D) formation property in the 1D formation evaluation when the 1D property can be related to the 2½ D physical magnitude combining the 2½ D physical magnitude image with the 1D facies log thereby generating a 2½ D facies image. The software will also generate a Virtual Plug representing an average estimate of all formation properties over a prescribed surface or volume in the vicinity of a selection made on the compilation (i.e., on the Virtual Core). When an interaction with the Virtual Core occurs, all results generated by those interactions will be restored.

U.S. Pat. No. 7,337,067 to Sanstrom describes a system and method for perceiving drilling learning through visualization. A 3D visualization of the earth model is used as a foundation for a new IT development strategy that focuses on perceiving “Drilling Learning” by an intuitive method. Symbols known as “Knowledge Attachments” are attached to each wellbore trajectory displayed in the 3D environment with each symbol indicating a specific event-such as one related to drilling operations or problems. A Knowledge Attachment system is described as useful to represent disparate data at once in such a manner that the interdependencies between the earth model and drilling operational data are evident and correlated. Operational issues and lessons learned from prior wells may be accessed and perceived in the context of the earth model. By understanding this information at the beginning of the well planning process operational efficiencies may be improved.

U.S. Patent Application Publication No. 20100125349 by Abasov, et al. discloses systems and methods for dynamically developing a wellbore plan with a reservoir simulator. The systems and methods relate to a plan for multiple wellbores with a reservoir simulator based on actual and potential reservoir performance.

What is needed is a system and method of more effectively producing a visualization of fluid flow in completion hardware and an associated reservoir. Such systems and methods would be desirable.

### SUMMARY

An exemplary embodiment of the present techniques relates to a method for creating a visualization representing location, type and fluid flow in a completion hardware configuration and fluid flow in a reservoir containing the completion hardware configuration. The exemplary method comprises obtaining data relating to a location and type of the completion hardware configuration. Data relating to fluid flow within the completion hardware configuration is obtained based on the location and type of the completion hardware. Data relating to fluid flow within the reservoir is also obtained. The exemplary method also comprises importing the data relating to the location and type of the completion hardware configuration and the fluid flow within the completion hardware configuration into a main program. Data relating to fluid flow within the reservoir is also imported into the main program. The exemplary method comprises providing a visualization that includes the data relating to the location and type of the completion hardware configuration and the fluid flow within the completion hardware configuration, along with the data relating to fluid flow within the reservoir.

In one exemplary method, a difference in format of the data relating to fluid flow within the completion hardware configuration relative to the data relating to fluid flow within the reservoir is taken into account when providing the visualization. The difference in format may include that the data relating to fluid flow within the completion hardware configuration includes a relatively large number of data elements per unit length or volume relative to the data relating to the fluid flow within the reservoir. Taking into account the difference in format may include normalizing the difference in format.

An exemplary method may comprise storing the data relating to location, type and fluid flow within the completion hardware configuration in an intermediate format relative to the data relating to fluid flow within the reservoir. The intermediate format may be readable by the program.

In one exemplary method of providing a visualization, time-independent data is included in the data relating to fluid flow within the completion hardware configuration. Time-dependent data may also be included in the data relating to fluid flow within the completion hardware configuration.

One exemplary method of providing a visualization comprises obtaining data relating to a location and type of additional completion hardware configurations. Data relating to fluid flow within the additional completion hardware configurations based on the location and type of the completion hardware may also be obtained. In addition, data relating to fluid flow within the reservoir based on the data relating to location, type and fluid flow within the additional completion hardware configurations may be obtained. The data relating to location, type and fluid flow within the additional completion hardware configurations and the reservoir may be imported into the main program. An impact on depletion of hydrocarbon resources in the reservoir based on the different completion hardware configurations may then be assessed.

An exemplary embodiment of the present techniques relates to a computer system that is adapted to create a visualization representing location, type and fluid flow in a completion hardware configuration and fluid flow in a reservoir containing the completion hardware configuration. The computer system comprises a processor and a non-transitory, machine-readable storage medium that stores machine-readable instructions for execution by the processor. The machine-readable instructions comprise code that, when executed by the processor, is adapted to cause the processor to obtain data relating to a location and type of the completion hardware configuration. Also included is code that obtains data relating to fluid flow within the completion hardware configuration based on the location and type of the completion hardware, and code that causes the processor to obtain data relating to fluid flow within the reservoir. The non-transitory, machine-readable storage medium comprises code that imports the data relating to the location and type of the completion hardware configuration and the fluid flow within the completion hardware configuration into a main program. Also included is code that imports the data relating to fluid flow within the reservoir into the main program. The non-transitory, machine-readable storage medium comprises code that provides a visualization that includes the data relating to the location and type of the completion hardware configuration and the fluid flow within the completion hardware configuration, along with the data relating to fluid flow within the reservoir.

In one exemplary computer system, the non-transitory, machine-readable storage medium comprises code that takes into account a difference in format of the data relating to fluid flow within the completion hardware configuration relative to the data relating to fluid flow within the reservoir when providing the visualization. The difference in format may be that the data relating to fluid flow within the completion hardware configuration has a relatively large number of data elements per unit length or volume relative to the data relating to the fluid flow within the reservoir. Taking into account the difference in format may include normalizing the difference in format.

A non-transitory, machine-readable storage medium of an exemplary computer system comprises code that stores the data relating to location, type and fluid flow within the completion hardware configuration in an intermediate format relative to the data relating to fluid flow within the reservoir. The intermediate format may be readable by the main program.

In an exemplary embodiment, the data relating to fluid flow within the completion hardware configuration includes time-independent data. The data relating to fluid flow within the completion hardware configuration may also include time-dependent data.

In an exemplary computer system, the non-transitory, machine-readable storage medium comprises code that, when executed by the processor, is adapted to obtain data relating to a location and type of additional completion hardware configurations. Code that obtains data relating to fluid flow within the additional completion hardware configurations based on the location and type of the completion hardware may also be included. Additionally, code that obtains data relating to fluid flow within the reservoir based on the data relating to location, type and fluid flow within the additional completion hardware configurations may be included. The non-transitory, machine-readable storage medium may store code that imports the data relating to location, type and fluid flow within the additional completion hardware configurations and fluid flow in a reservoir into the main program. Further, code that assesses an impact on depletion of hydrocarbon resources in the reservoir based on the different completion hardware configurations may be included.

Another exemplary embodiment of the present techniques relates to a method for producing hydrocarbons from an oil and/or gas field using a visualization representing location, type and fluid flow in a completion hardware configuration and fluid flow in a reservoir in the oil and/or gas field. The reservoir contains the completion hardware configuration. The exemplary method comprises obtaining data relating to a location and type of the completion hardware configuration. Data relating to fluid flow within the completion hardware configuration based on the location and type of the completion hardware is obtained, as is data relating to fluid flow within the reservoir. Thereafter, the data relating to the location and type of the completion hardware configuration and the fluid flow within the completion hardware configuration is imported into a main program. Similarly, data relating to fluid flow within the reservoir is also imported into the main program. A visualization is provided. The visualization includes the data relating to the location and type of the completion hardware configuration and the fluid flow within the completion hardware configuration, along with the data relating to fluid flow within the reservoir. Using the visualization, hydrocarbons are extracted from the oil and/or gas field.

One exemplary embodiment of the method of extracting hydrocarbons comprises taking into account a difference in format of the data relating to fluid flow within the completion hardware configuration relative to the data relating to fluid flow within the reservoir when providing the visualization. The difference in format may include that the data relating to fluid flow within the completion hardware configuration has a relatively large number of data elements per unit length or volume relative to the data relating to the fluid flow within the reservoir. Taking into account the difference in format may comprise normalizing the difference.

### BRIEF DESCRIPTION OF THE DRAWINGS

Advantages of the present techniques may become apparent upon reviewing the following detailed description and drawings of non-limiting examples of embodiments in which:

FIG. 1 is a diagram showing a computer program that provides a visualization in accordance with an exemplary embodiment of the present techniques;

FIG. 2 is a diagram of a well completion simulator plug-in in accordance with an exemplary embodiment of the present techniques;

FIG. 3 is a diagram of a visualization of location and fluid flow data in completion hardware and a reservoir produced in accordance with an exemplary embodiment of the present techniques;

FIG. 4 is a graph showing a two-dimensional (2D) representation of oil flux from different parts of completion hardware, as well as a graph of the reservoir node to well node transmissibility in accordance with an exemplary embodiment of the present techniques;

FIG. 5 is a graph showing a visualization of fluid production data in accordance with an exemplary embodiment of the present techniques;

FIG. 6 is a diagram of a visualization showing time-dependent properties inside the completion hardware and the reservoir in accordance with an exemplary embodiment of the present techniques;

FIG. 7 is a process flow diagram showing a method for providing a visualization of fluid flow, in accordance with an exemplary embodiment of the present techniques;

FIG. 8 is a process flow diagram showing a method for producing hydrocarbons from a subsurface region such as an oil and/or gas field according to exemplary embodiments of the present techniques; and

FIG. 9 is a block diagram of a computer system that may be used to perform a method for providing a visualization of fluid flow according to exemplary embodiments of the present techniques.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

### DETAILED DESCRIPTION

In the following detailed description section, the specific embodiments of the present invention are described in connection with preferred embodiments. However, to the extent that the following description is specific to a particular embodiment or a particular use of the present invention, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent.

As used herein, the terms “completion hardware” or “completion” refers to hardware that provides an interface between a wellbore interval and a reservoir interval. Examples of components that may comprise various configurations of completion hardware include inflow control devices, inflow control valves, slotted liners, perforated liners, open hole completions, wire wrap screens, blank pipes, and the like.

As used herein, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and/or a computer. One or more computer components can reside within a process and/or thread of execution and a computer component can be localized on one computer and/or distributed between two or more computers.

As used herein, the terms “computer-readable medium”, “tangible machine-readable medium” or the like refer to any tangible storage that participates in providing instructions to a processor for execution. Such a medium may take many forms, including but not limited to, non-volatile media, and volatile media. Non-volatile media includes, for example, NVRAM, or magnetic or optical disks. Volatile media includes dynamic memory, such as main memory. Computer-readable media may include, for example, a floppy disk, a flexible disk, hard disk, magnetic tape, or any other magnetic medium, magneto-optical medium, a CD-ROM, any other optical medium, a RAM, a PROM, and EPROM, a FLASH-EPROM, a solid state medium like a holographic memory, a memory card, or any other memory chip or cartridge, or any other physical medium from which a computer can read. When the computer-readable media is configured as a database, it is to be understood that the database may be any type of database, such as relational, hierarchical, object-oriented, and/or the like. Accordingly, exemplary embodiments of the present techniques may be considered to include a tangible storage medium or tangible distribution medium and prior art-recognized equivalents and successor media, in which the software implementations embodying the present techniques are stored.

As used herein, the term “property” refers to a characteristic associated with different topological elements on a per element basis.

As used herein, the term “reservoir” refers to a formation or a portion of a formation that includes sufficient permeability and porosity to hold and transmit fluids, such as hydrocarbons or water.

As used herein, the term “reservoir interval” refers to a finite region of a reservoir.

As used herein, the terms “shared earth model” or “shared earth environment” refers to a geometrical model of a portion of the earth that may also contain material properties. The model is shared in the sense that it integrates the work of several specialists involved in the model's development (non-limiting examples may include such disciplines as geologists, geophysicists, petrophysicists, well log analysts, drilling engineers and reservoir engineers) who interact with the model through one or more application programs.

As used herein, the terms “well” or “wellbore” refer to cased, cased and cemented, or open-hole wellbores, and may be any type of well, including, but not limited to, a producing well, an experimental well, an exploratory well, and the like. Wellbores may be vertical, horizontal, any angle between vertical and horizontal, diverted or non-diverted, and combinations thereof, for example a vertical well with a non-vertical component.

As used herein, the term “wellbore interval” refers to a finite length along a wellbore.

Some portions of the detailed description which follows are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions using the terms such as “adjusting”, “comparing”, “computing”, “creating”, “defining”, “determining”, “displaying”, “importing”, “limiting”, “obtaining”, “processing”, “performing”, “predicting”, “producing”, “providing”, “selecting”, “storing”, “transforming”, “updating” or the like, refer to the action and processes of a computer system, or similar electronic computing device, that transforms data represented as physical (electronic) quantities within the computer system's registers and memories into other data similarly represented as physical quantities within the computer system memories or registers or other such information storage, transmission or display devices. Example methods may be better appreciated with reference to flow diagrams.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

An exemplary embodiment of the present techniques provides co-visualization of fluid flow simulation results within well completions and in the hydrocarbon reservoir in which the completions are located. In addition, various time-dependent and time-independent properties of the hydrocarbon reservoir model may also be included in a visualization according to the present techniques.

In an exemplary embodiment, a fluid flow solution in the well completions and the reservoir may be generated using known techniques. Values of selected well-completions and reservoir attributes may be generated at set time intervals. Data from multiple completion hardware designs, at single or multiple times, may be imported into a main program that provides the fluid flow analysis for the reservoir. Once imported, the data can be visualized and analyzed in a two-dimensional (2D) or three-dimensional (3D) environment in the main program. The main program may contain a geologic and/or a reservoir simulation model. The simultaneous presence of well- and reservoir-related data in the main program may provide a synergistic environment for understanding the impact of completions on the long-term performance of the reservoir.

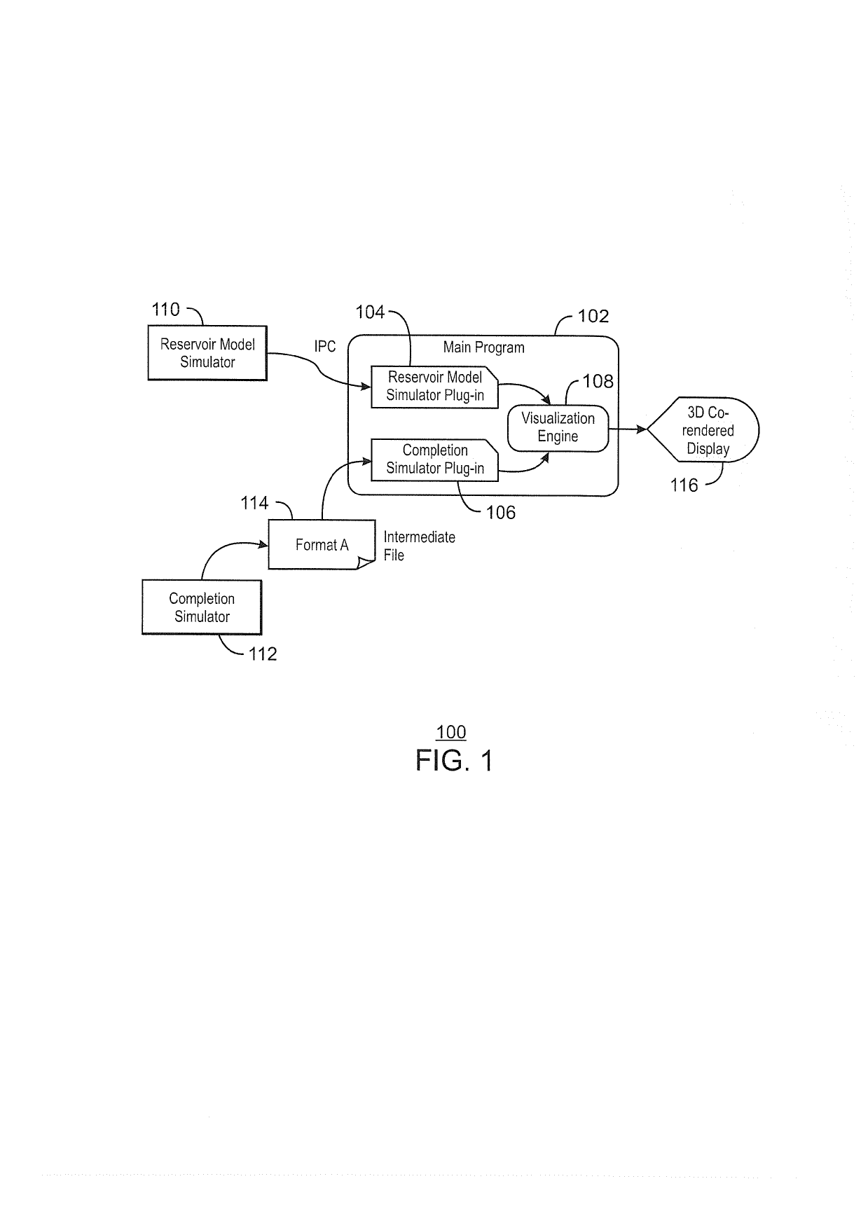

FIG. 1 is a diagram showing a computer program that provides a visualization in accordance with an exemplary embodiment of the present techniques. The diagram is generally referred to by the reference number 100.

The diagram 100 shows a main program 102, which receives data regarding fluid flow in a reservoir and data regarding fluid flow in one or more designs or configurations of completion hardware. The data relating to fluid flow in the reservoir may be derived in part from a shared earth environment. The main program 102 includes a reservoir model simulator plug-in 104 and a completion simulator plug-in 106. The reservoir model simulator plug-in 104 receives data relating to fluid flow in the reservoir from a reservoir model simulator 110, which is external to the main program 102. The completion simulator plug-in 106 receives data relating to fluid flow in one or more completion hardware configurations from a completion simulator 112.

The completion simulator 112 may create a model for one or more completion designs that are to be evaluated. The models contain the data related to the location and types of the completions along with the wellbore trajectory and various properties required to generate a fluid flow solution. Each model may be simulated to generate the data, at single or multiple time instances, for variation in various attributes related to the completions along the wellbore trajectory. As an example, these attributes could relate to the flow rates of hydrocarbon and water entering different parts of the completion hardware from the hydrocarbon reservoir.

In the exemplary embodiment shown in FIG. 1, the data produced by the completion simulator 112 may be stored in an intermediate file 114 in an intermediate format (format A). The intermediate format may be different than the format of the reservoir data provided by the reservoir model simulator 110. In an exemplary embodiment, the different format is at least in part attributable to the fact that a relatively large number of data elements per unit of length or volume may be available for completion hardware relative to a corresponding reservoir. The completion simulator plug-in 106 may be configured to read this intermediate file 114 to extract the information related to the well trajectory, completions locations and fluid-flow simulation results along the well trajectory.

With respect to fluid flow in the reservoir, a reservoir model is generated in the reservoir model simulator 110. The model is populated with various properties that are needed for the fluid flow simulation. Time-dependent attributes related to the fluid flow in the reservoir may be obtained by performing a simulation in the reservoir model simulator 110. The time-dependent and time-independent data is passed on to the reservoir model simulator plug-in 104 of the main program 102 via an inter-process communication (IPC) link. A geologic model for the reservoir may also be imported into the main program 102 in this manner. When processing the data, the main program 102 may be adapted to account for differences in format between data corresponding to the reservoir and data corresponding to one or more completion hardware configurations. For example, the main program 102 may take into account that the completion hardware data comprises a relatively large number of data elements per unit length or volume and normalize the data when producing a visualization that includes both types of data.

The main program 102 includes a visualization engine (VE) 108 that receives data from the reservoir model simulator plug-in 104 and the completion simulator plug-in 106. Attributes related to the reservoir model are also sent to the VE 108 by the reservoir model simulator plug-in 104. The VE 108 in turn makes this information available to one or more display units either in 2D or in 3D based on a user's request.

In the exemplary embodiment shown in FIG. 1, a 3D co-rendered display or visualization 116 is produced by the VE 108. According to an exemplary embodiment, the 3D co-rendered display or visualization 116 may comprise a portion that relates to fluid flow within the reservoir and a portion that relates to location, type and fluid flow within one or more configurations of completion hardware in the reservoir. Moreover, the visualization may be used to evaluate the effectiveness of different configurations of completion hardware before deployment.

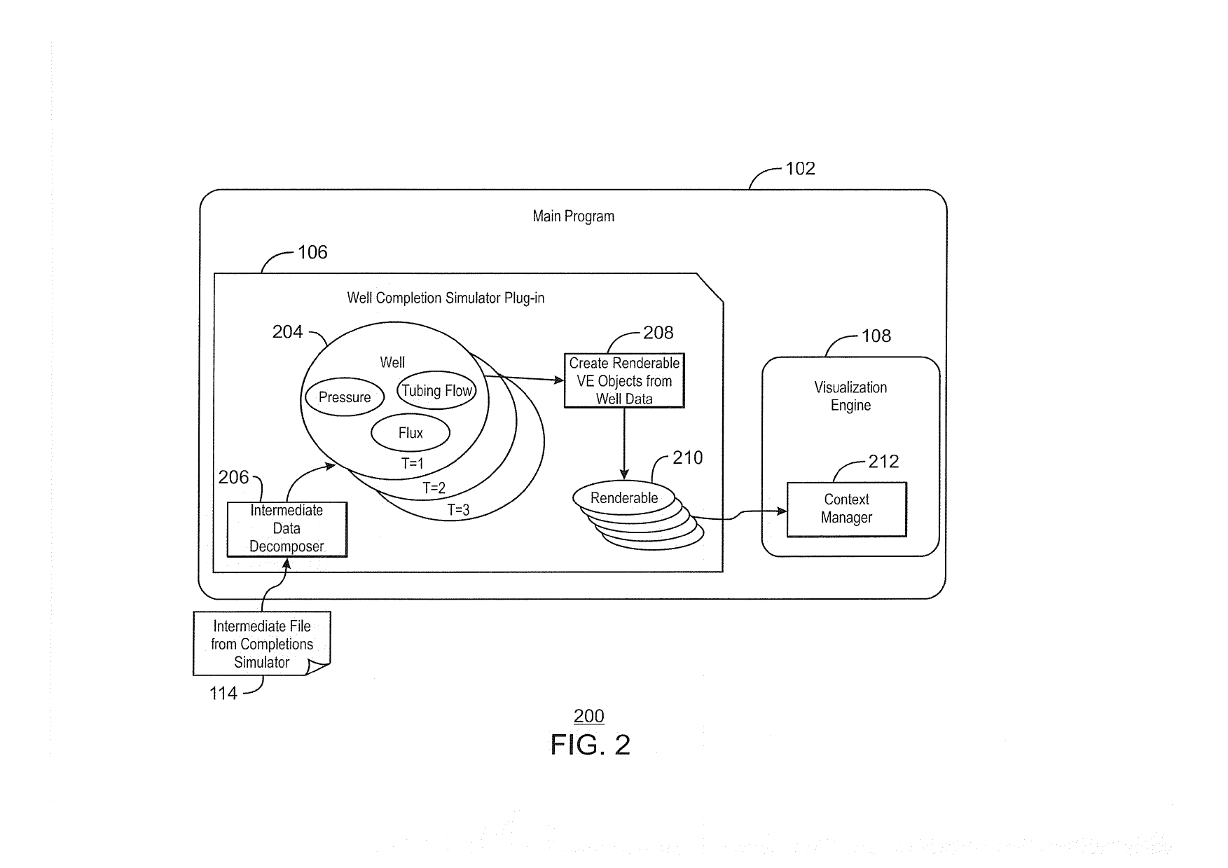

FIG. 2 is a diagram of the well completion simulator plug-in 106 in accordance with an exemplary embodiment of the present techniques. The diagram is generally referred to by the reference number 200. In the exemplary embodiment shown in the diagram 200, the well completion simulator plug-in 106 receives data from an intermediate file 114, which may be created by the well completion simulator 112. As explained herein, the data from the intermediate file 114 may be in a different format relative to data provided by the reservoir model simulator 110.

In particular, data from the intermediate file 114 is received by an intermediate file decomposer 206. This data is decomposed to extract information such as well trajectory, completion hardware location and time-dependent information about various fluid-flow attributes related to one or more configurations (actual or simulated) of completion hardware. The intermediate file decomposer 206 may produce data corresponding to a plurality of times (T=1, T=2, etc.), each of which may include physical and fluid flow characteristics of a specific completion hardware configuration. Examples of data that may be included in the performance of completion hardware at various times indicated in 204 include pressure, tubing flow and flux.

An object module 208 of the well completion simulator plug-in 106 produces a plurality of renderable objects 210 based on the times instances available from 204. The renderable objects 210 may be related to a corresponding well and may include various depth-varying fluid flow attributes. The renderable objects 210 may be provided to the VE 108 via a context manager 212. In turn, the VE 108 may employ the renderable objects 210 to produce visualizations of fluid flow according to the present techniques.

Once all the relevant data has been imported into the main program 102, location, type and fluid flow within one or more configurations of well completion hardware and the reservoir can be co-visualized in the main program 102 via the VE 108. An advantage of co-visualizing this data is to facilitate fast detection of outlier data points that may not be easily detected when data for completion hardware is viewed separately from reservoir data. Once the data about the completion hardware and the reservoir model is imported into the main program 102, it can be saved in a format usable by the main program 102. This eliminates the need to use separate software for accessing this specific interdisciplinary data for future analysis as all the information is then available inside the main program 102.

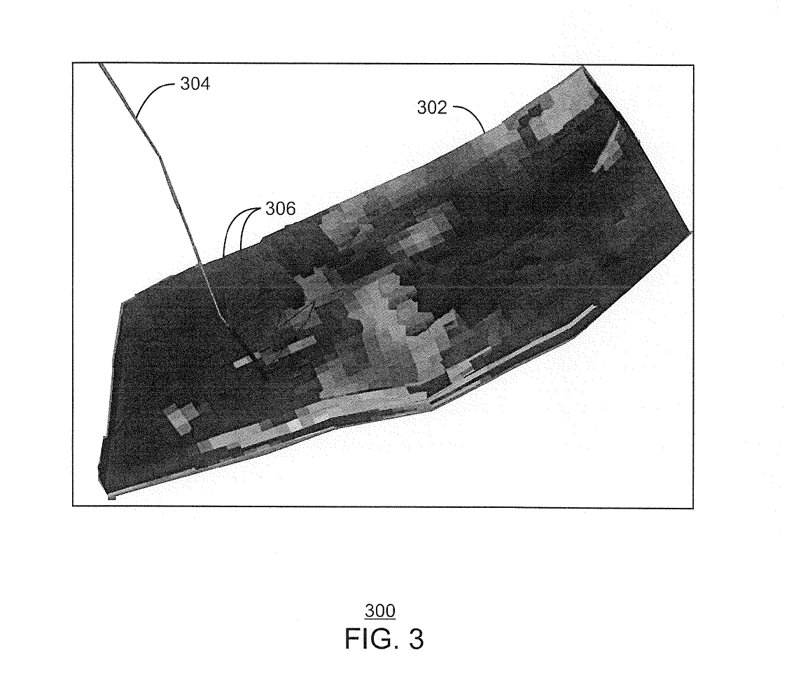

FIG. 3 is a diagram of a visualization of fluid flow data in completion hardware and a reservoir produced in accordance with an exemplary embodiment of the present techniques. The visualization is generally referred to by the reference number 300. The visualization 300 is an example of the co-visualization of location, type and fluid flow data for well completion hardware, as interpreted by the well completion simulator plug-in 106 and fluid flow data for the corresponding reservoir, as interpreted by the reservoir model simulator plug-in 104.

A reservoir model 302 is depicted in 3D. Various degrees of shading are used to represent node properties from a reservoir simulation. A well trajectory 304 is shown in conjunction with fluid flow data 306 for one or more configurations of well completion hardware. Different types of location and fluid flow data 306 may be represented by colored cylinders and lines along the well trajectory 304.

As an example of data imported from the completion simulator 112, a colored line along the well trajectory 304 may represent the variation in the oil flux entering the completion hardware from different parts of the reservoir. Oil flux represents the amount of oil that enters the well per unit time per unit length of the completion hardware.

In addition, the visualization 300 also may employ colored cells to show information that has been obtained from a reservoir simulation model via the reservoir model simulator 110. These cells may be colored by the value of horizontal permeability for the grid-block of the reservoir that is represented by them. Horizontal permeability is a physical quantity that signifies the ease with which fluids can flow through a part of the hydrocarbon reservoir along the horizontal direction with respect to a given coordinate system. The 3D representation of this data makes it easier for an interdisciplinary team of reservoir and subsurface engineers to analyze the impact of placing the completions on the well. This is because all the data related to the fluid flow, within the completion hardware, as well as, the hydrocarbon reservoir, is present in the main program 102.

In an exemplary embodiment, the main program 102 may provide the option of animating the time-dependent attributes for the completion hardware and the reservoir. This helps in understanding the long-term behavior of the completion hardware and the associated impact on reservoir performance. An extension of this approach is to import data from multiple completion hardware configurations or designs to allow the user to compare their long-term impact on the depletion of the reservoir.

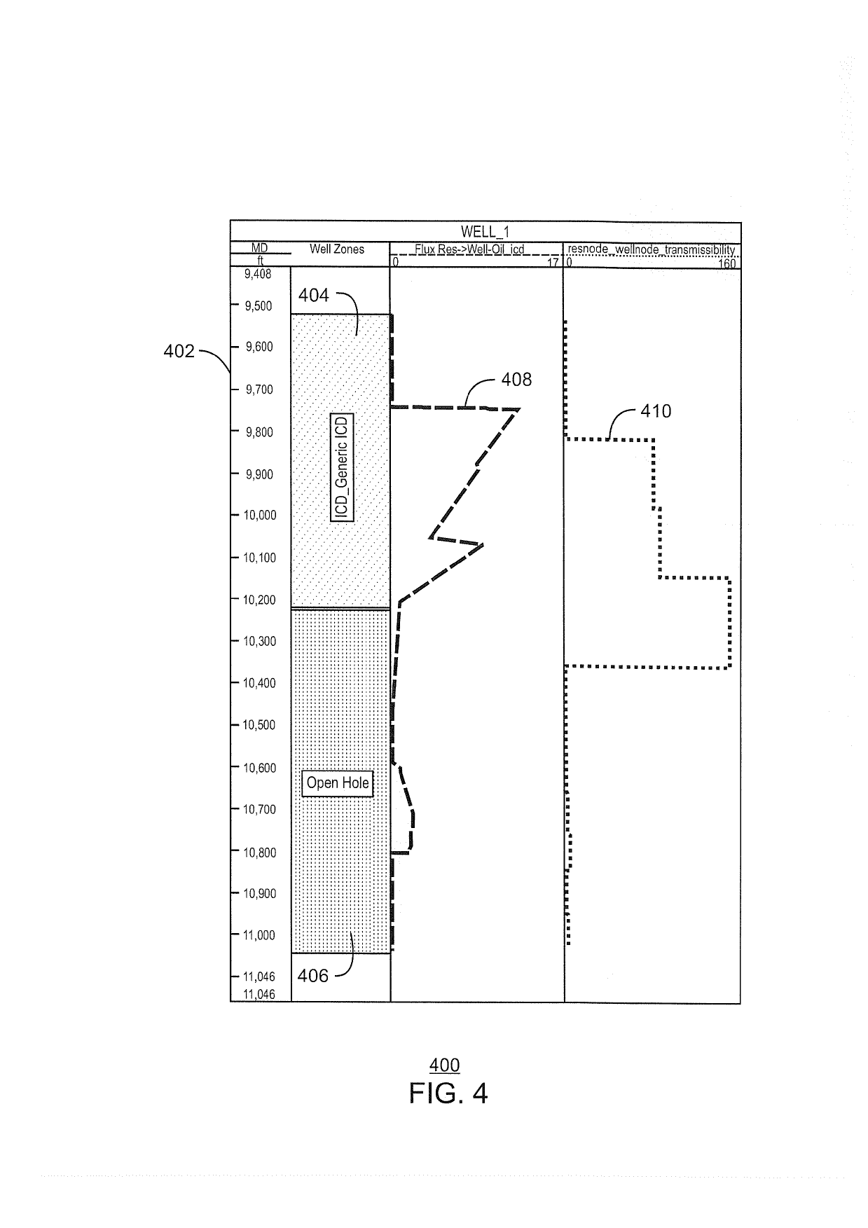

FIG. 4 is a graph showing a 2D representation of oil flux from different parts of completion hardware in accordance with an exemplary embodiment of the present techniques. The graph is generally referred to by the reference number 400. A y-axis 402 represents measured depth in feet or meters. In a left panel of the graph 400, two regions 404 and 406 represent different types of completions. A center panel shows a trace 408, which represents data related to flux. In a right panel, a trace 410 represents well node transmissibility (e.g., transmissibility between the reservoir grid-block and the well segment). In an exemplary embodiment, the flux is obtained from the completions simulator 112 while the transmissibility data is obtained from the reservoir model simulator 110.

A user can utilize the information shown in the graph 400 to get a quantitative idea about the amount of oil flux entering the well from different parts of well completions. The graph 400 may also be configured to display the completion types along the wellbore trajectory. The user can also get the information about the completion type by performing a query on the objects corresponding to completions in a 3D viewer associated with the main program 102. This helps in correlating the observed flow behavior with the type of completions present in a particular part of the well.

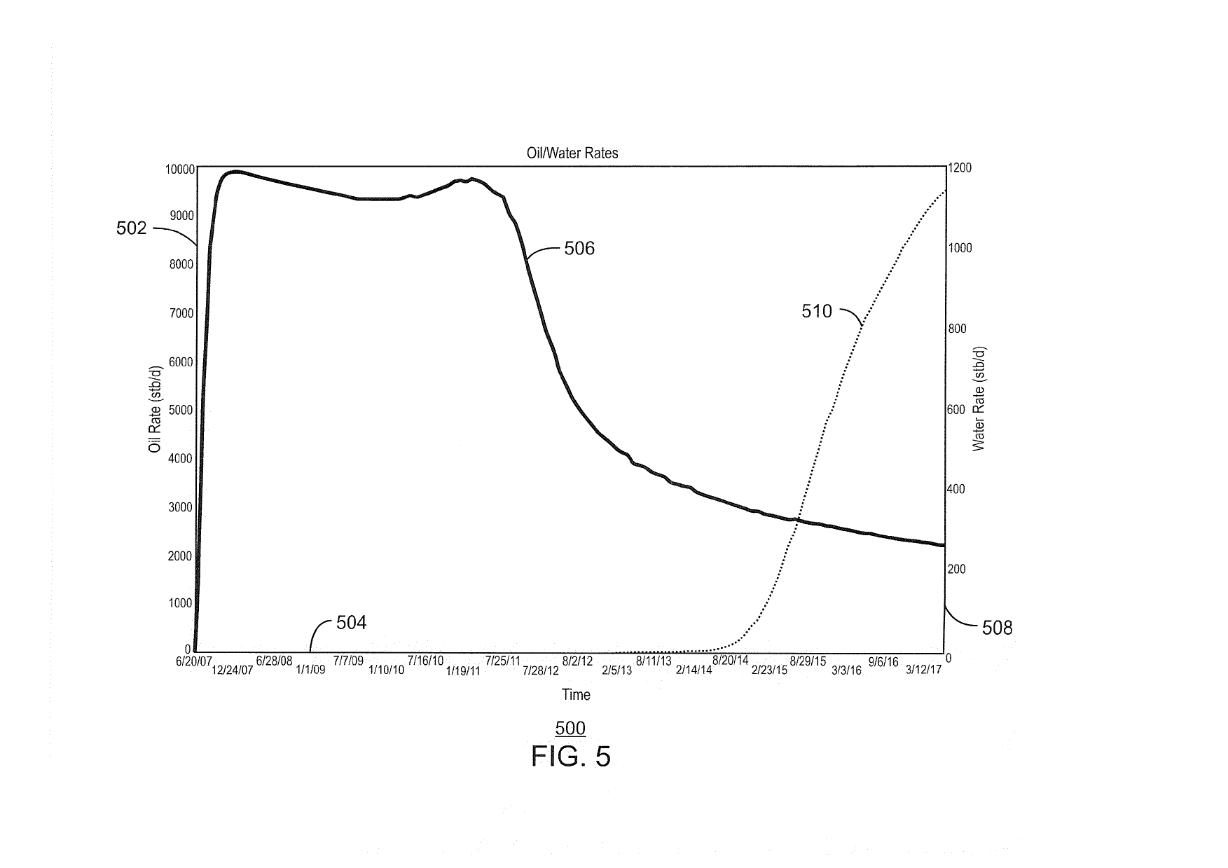

FIG. 5 is a graph showing a visualization of fluid production data in accordance with an exemplary embodiment of the present techniques. The graph is generally referred to by the reference number 500. The graph 500 represents the long-term impact of the elements of the data shown in FIG. 3 and FIG. 4.

A y-axis 502 represents an oil production rate in units of barrels/day. An x-axis 504 represents time. A trace 506 represents an average phase rate for oil as measured by the y-axis 502. A right-hand y-axis 508 represents a water rate in units of barrels/day. A trace 510 represents an average phase rate for water as measured by the right-hand y-axis 508.

The data represented in FIG. 5 shows the long-term impact of placing completion hardware on the production of oil and water from the well. A combination of the data represented by FIG. 3, FIG. 4 and FIG. 5 provides comprehensive information about the location of the completions, their impact on production of hydrocarbons from different parts of the well and their long-term impact on the overall production performance of the well.

According to the present techniques, learning about the performance of completions can be extended to other wells that have similar near-well reservoir properties. This can significantly improve the quality of initial completion designs that are tested for the other wells.

In an exemplary embodiment, 2D slices of a hydrocarbon reservoir model may be created. The 2D slices may provide an understanding of the impact of completions on the near-well fluid flow within the hydrocarbon reservoir.

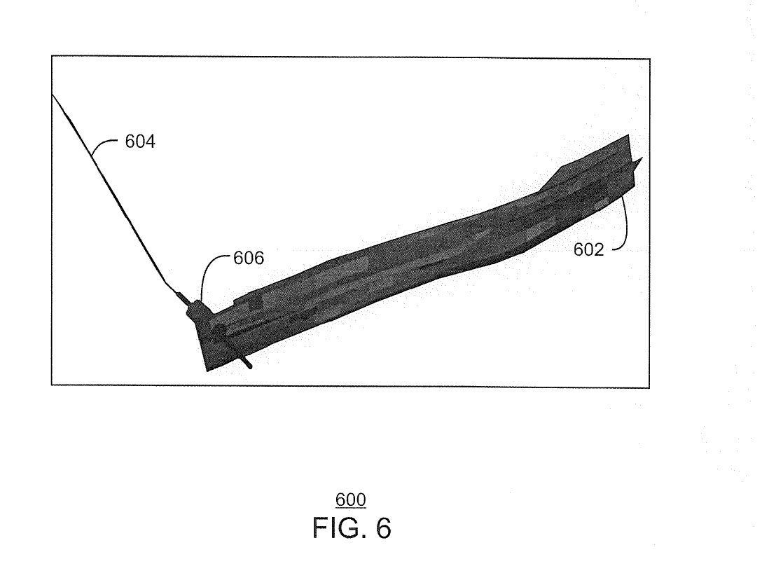

FIG. 6 is a diagram of a visualization showing time-dependent properties in accordance with an exemplary embodiment of the present techniques. The diagram is generally referred to by the reference number 600. The diagram shows a slice of the reservoir model 602, which is intersected by a well trajectory 604. As explained herein, a plurality of cylinders 606 represent the placement of completion hardware, as well as various fluid flow parameters associated with the completion hardware.

The plurality of cylinders 606 may represent time-dependent properties such as water production rate, which can be posted and animated on a slice to assess the impact of the placement of completion hardware. Moreover, a colored cylinder may be used to depict the rate at which water enters a corresponding completion. The radius of the cylinder at a given location may be proportional to the flow rate of water at that location. The slice of the reservoir model shown in FIG. 6 contains the information about water saturation at different locations in the slice. All the information presented in FIG. 6 is time-dependent and may be animated in the main program 102.

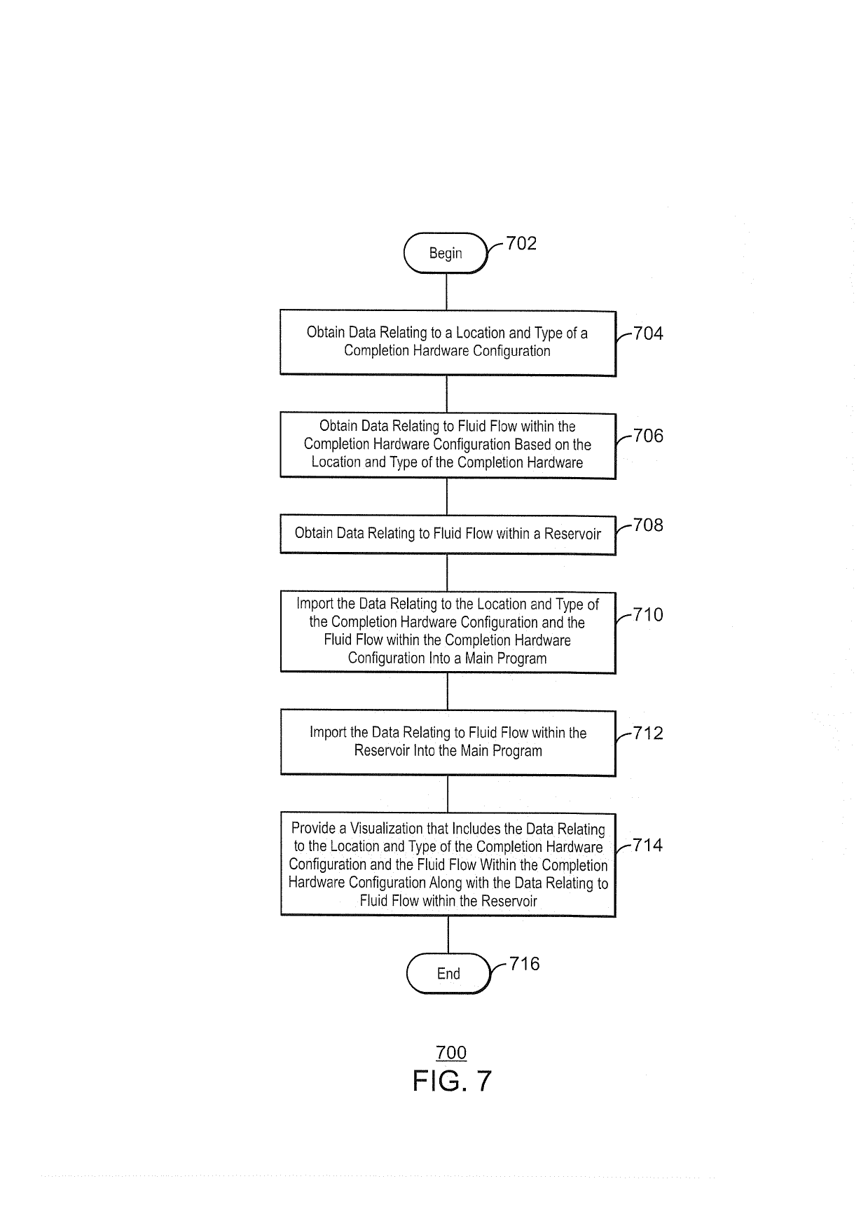

FIG. 7 is a process flow diagram showing a method for providing a visualization of location, type and fluid flow in a completion hardware configuration and fluid flow in a reservoir containing the completion hardware configuration in accordance with an exemplary embodiment of the present techniques. At block 702, the method begins.

Data relating to a location and type of the completion hardware configuration is obtained, as shown at block 704. At block 706, data relating to fluid flow within the completion hardware configuration based on the location and type of the completion hardware is obtained. Data relating to fluid flow within the reservoir is obtained, as shown at block 708.

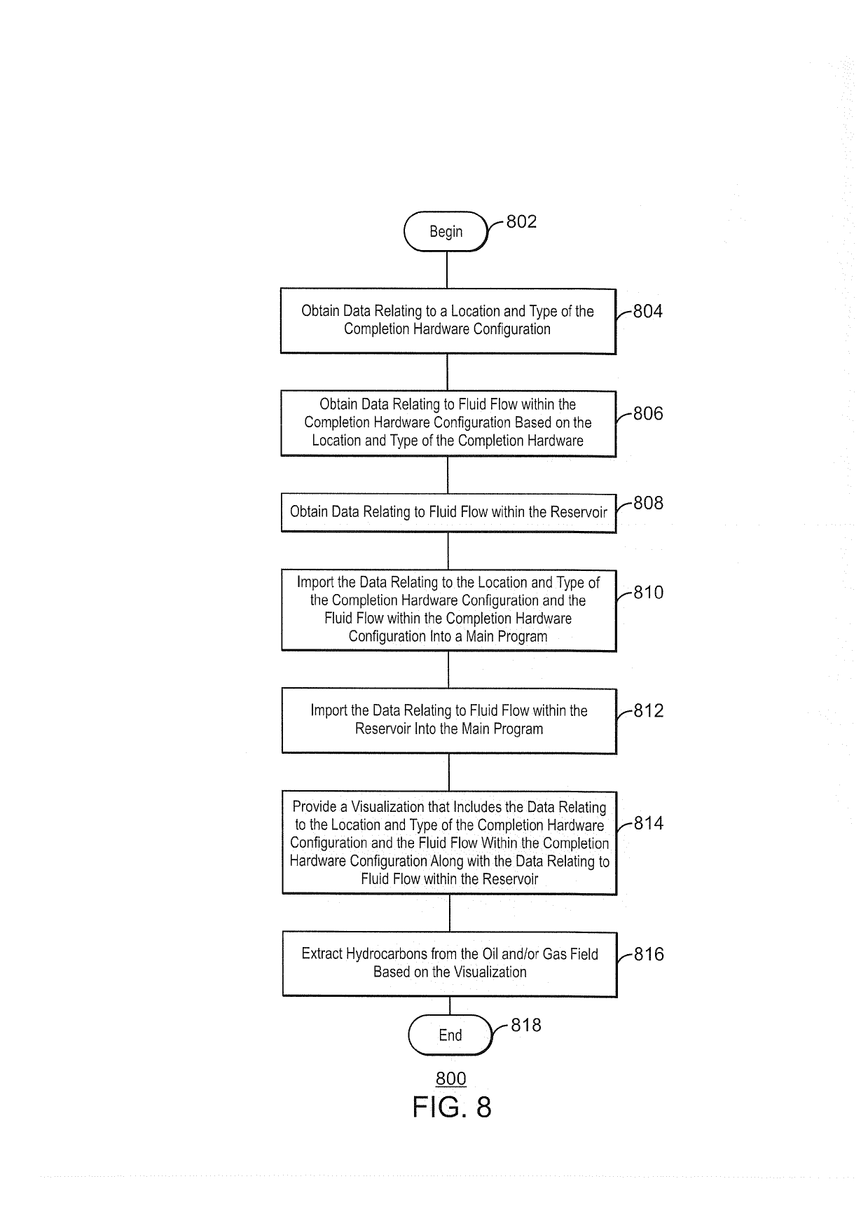

At block 710, data relating to the location and type of the completion hardware configuration and the fluid flow within the completion hardware configuration is imported into a main program. Data relating to fluid flow within the reservoir is then imported into the main program, as shown at block 712. As shown at block 714, a visualization that includes the data relating to the location and type of the completion hardware configuration and the fluid flow within the completion hardware configuration is provided, along with the data relating to fluid flow within the reservoir. The process ends at block 716. FIG. 8 is a process flow diagram showing a method for producing hydrocarbons from a subsurface region such as an oil and/or gas field according to exemplary embodiments of the present techniques. The process is generally referred to by the reference number 800. According to an exemplary embodiment of the present techniques, hydrocarbon production is facilitated through the use of a visualization of fluid flow in completion hardware (or a simulation thereof) and an associated reservoir (or a simulation thereof). The process begins at block 802.

Those of ordinary skill in the art will appreciate that the present techniques may facilitate the production of hydrocarbons by producing visualizations that allow geologists, engineers and the like to determine a course of action to take to enhance hydrocarbon production from a subsurface region. By way of example, a visualization produced according to an exemplary embodiment of the present techniques may allow an engineer or geologist to determine the placement location and type of completions to increase production of hydrocarbons from a subsurface region. At block 802, the process begins.

At block 804, data relating to a location and type of the completion hardware configuration is obtained. Data relating to fluid flow within the completion hardware configuration based on the location and type of the completion hardware is obtained, as shown at block 806. At block 808, data relating to fluid flow within the reservoir is obtained.

The data relating to the location and type of the completion hardware configuration and the fluid flow within the completion hardware configuration is imported into a main program, as shown at block 810. At block 812, the data relating to fluid flow within the reservoir is imported into the main program.

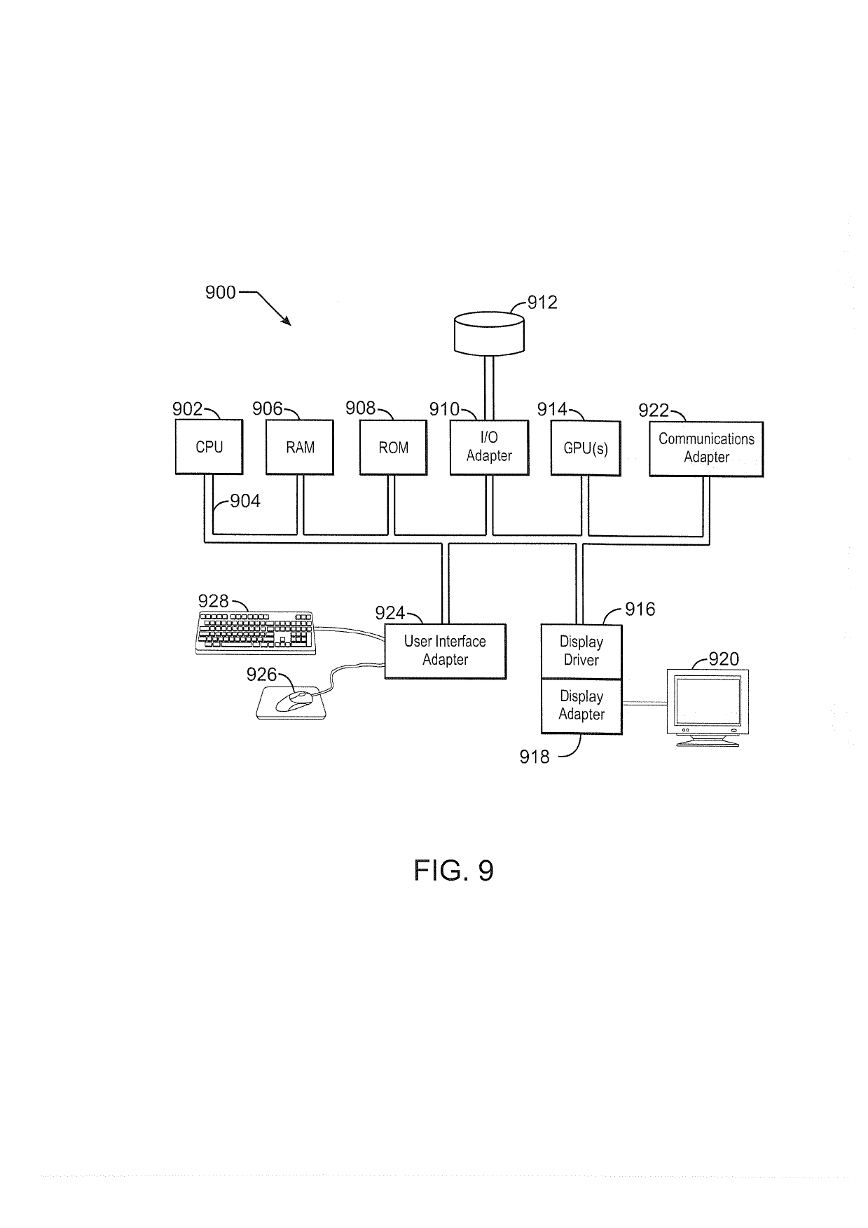

At block 814, a visualization that includes the data relating to the location of the completion hardware configuration, the type of the completion hardware configuration and the fluid flow within the completion hardware configuration is provided, along with the data relating to fluid flow within the reservoir. Hydrocarbons are extracted from the oil and/or gas field based on the visualization, as shown at block 816. At block 818, the process ends. FIG. 9 is a block diagram of a computer system that may be used to perform a method for providing a visualization of fluid flow according to exemplary embodiments of the present techniques. The computer network is generally referred to by the reference number 900.

A central processing unit (CPU) 902 is coupled to system bus 904. The CPU 902 may be any general-purpose CPU, although other types of architectures of CPU 902 (or other components of exemplary system 900) may be used as long as CPU 902 (and other components of system 900) supports the inventive operations as described herein. Those of ordinary skill in the art will appreciate that, while only a single CPU 902 is shown in FIG. 9, additional CPUs may be present. Moreover, the computer system 900 may comprise a networked, multi-processor computer system. The CPU 902 may execute the various logical instructions according to various exemplary embodiments. For example, the CPU 902 may execute machine-level instructions for performing processing according to the operational flow described above in conjunction with FIG. 7 or FIG. 8.

The computer system 900 may also include computer components such as computer-readable media. Examples of computer-readable media include a random access memory (RAM) 906, which may be SRAM, DRAM, SDRAM, or the like. The computer system 900 may also include additional computer-readable media such as a read-only memory (ROM) 908, which may be PROM, EPROM, EEPROM, or the like. RAM 906 and ROM 908 hold user and system data and programs, as is known in the art. The computer system 900 may also include an input/output (I/O) adapter 910, a communications adapter 922, a user interface adapter 924, and a display adapter 918. In an exemplary embodiment of the present techniques, the display adapter 918 may be adapted to provide a 3D representation of a 3D earth model. Moreover, an exemplary embodiment of the display adapter 918 may comprise a visualization engine or VE that is adapted to provide a visualization of extracted data. The I/O adapter 910, the user interface adapter 924, and/or communications adapter 922 may, in certain embodiments, enable a user to interact with computer system 900 in order to input information.

The I/O adapter 910 preferably connects a storage device(s) 912, such as one or more of hard drive, compact disc (CD) drive, floppy disk drive, tape drive, etc. to computer system 900. The storage device(s) may be used when RAM 906 is insufficient for the memory requirements associated with storing data for operations of embodiments of the present techniques. The data storage of the computer system 900 may be used for storing information and/or other data used or generated as disclosed herein.

The computer system 900 may comprise one or more graphics processing units (GPU(s)) 914 to perform graphics processing. Moreover, the GPU(s) 914 may be adapted to provide a visualization useful in performing a well completion planning process according to the present techniques. The GPU(s) 914 may communicate via a display driver 916 with a display adapter 918. The display adapter 918 may produce a visualization on a display device 920. Moreover, the display device 920 may be used to display information or a representation pertaining to a portion of a subsurface region under analysis, such as displaying a generated well completion design, according to certain exemplary embodiments.

A user interface adapter 924 may be used to couple user input devices. For example, the user interface adapter 924 may connect devices such as a pointing device 926, a keyboard 928, and/or output devices to the computer system 900.

The architecture of system 900 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

The present techniques may be susceptible to various modifications and alternative forms, and the exemplary embodiments discussed above have been shown only by way of example. However, the present techniques are not intended to be limited to the particular embodiments disclosed herein. Indeed, the present techniques include all alternatives, modifications, and equivalents falling within the spirit and scope of the appended claims.

What is claimed is:

1. A method for creating a visualization representing fluid flow in a completion hardware configuration and a reservoir containing the completion hardware configuration, comprising:
obtaining data relating to a location and type of the completion hardware configuration;
obtaining data relating to fluid flow within the completion hardware configuration based on the location and type of the completion hardware;
obtaining data relating to fluid flow within the reservoir;
importing the data relating to the location and type of the completion hardware configuration and the fluid flow within the completion hardware configuration into a main program;
importing the data relating to fluid flow within the reservoir into the main program; and
providing a visualization that includes the data relating to the location and type of the completion hardware configuration and the fluid flow within the completion hardware configuration, along with the data relating to fluid flow within the reservoir.

2. The method recited in claim 1, comprising taking into account a difference in format of the data relating to fluid flow within the completion hardware configuration relative to the data relating to fluid flow within the reservoir when providing the visualization.

3. The method recited in claim 2, wherein the difference in format includes that the data relating to fluid flow within the completion hardware configuration includes a relatively large number of data elements per unit length or volume relative to the data relating to the fluid flow within the reservoir.

4. The method recited in claim 2, wherein taking into account comprises normalizing the difference in format.

5. The method recited in claim 1, comprising storing the data relating to location, type and fluid flow within the completion hardware configuration in an intermediate format relative to the data relating to fluid flow within the reservoir, the intermediate format being readable by the main program.

6. The method recited in claim 1, comprising including time-independent data in the data relating to fluid flow within the completion hardware configuration.

7. The method recited in claim 1, comprising including time-dependent data in the data relating to fluid flow within the completion hardware configuration.

8. The method recited in claim 1, comprising:
obtaining data relating to a location and type of additional completion hardware configurations;
obtaining data relating to fluid flow within the additional completion hardware configurations based on the location and type of the completion hardware;
obtaining data relating to fluid flow within the reservoir based on the data relating to fluid flow within the additional completion hardware configurations;
importing the data relating to location, type and fluid flow within the additional completion hardware configurations and the fluid flow in the reservoir into the main program; and
assessing an impact on depletion of hydrocarbon resources in the reservoir based on the different completion hardware configurations.

9. A computer system that is adapted to create a visualization representing location, type and fluid flow in a completion hardware configuration and the fluid flow within a reservoir containing the completion hardware configuration, the computer system comprising:
a processor; and
a non-transitory, machine-readable storage medium that stores machine-readable instructions for execution by the processor, the machine-readable instructions comprising:
code that, when executed by the processor, is adapted to cause the processor to obtain data relating to a location and type of the completion hardware configuration;
code that, when executed by the processor, is adapted to cause the processor to obtain data relating to fluid flow within the completion hardware configuration based on the location and type of the completion hardware;
code that, when executed by the processor, is adapted to cause the processor to obtain data relating to fluid flow within the reservoir;
code that, when executed by the processor, is adapted to cause the processor to import the data relating to the location and type of the completion hardware configuration and the fluid flow within the completion hardware configuration into a main program;
code that, when executed by the processor, is adapted to cause the processor to import the data relating to fluid flow within the reservoir into the main program; and
code that, when executed by the processor, is adapted to cause the processor to provide a visualization that includes the data relating to the location and type of the completion hardware configuration and the fluid flow within the completion hardware configuration, along with the data relating to fluid flow within the reservoir.

10. The computer system recited in claim 9, wherein the non-transitory, machine-readable storage medium comprises code that, when executed by the processor, is adapted to take into account a difference in format of the data relating to fluid flow within the completion hardware configuration relative to the data relating to fluid flow within the reservoir when providing the visualization.

11. The computer system recited in claim 10, wherein the difference in format includes that the data relating to fluid flow within the completion hardware configuration includes a relatively large number of data elements per unit length or volume relative to the data relating to the fluid flow within the reservoir.

12. The computer system recited in claim 10, wherein taking into account comprises normalizing the difference in format.

13. The computer system recited in claim 9, wherein the non-transitory, machine-readable storage medium comprises code that, when executed by the processor, is adapted to store the data relating to location, type and fluid flow within the completion hardware configuration in an intermediate format relative to the data relating to fluid flow within the reservoir, the intermediate format being readable by the main program.

14. The computer system recited in claim 9, wherein the data relating to fluid flow within the completion hardware configuration includes time-independent data.

15. The computer system recited in claim 9, wherein the data relating to fluid flow within the completion hardware configuration includes time-dependent data.

16. The computer system recited in claim 9, wherein the non-transitory, machine-readable storage medium comprises:
code that, when executed by the processor, is adapted to obtain data relating to a location and type of additional completion hardware configurations;
code that, when executed by the processor, is adapted to obtain data relating to fluid flow within the additional completion hardware configurations based on the location and type of the completion hardware;
code that, when executed by the processor, is adapted to obtain data relating to fluid flow within the reservoir based on the data relating to fluid flow within the additional completion hardware configurations;
code that, when executed by the processor, is adapted to import the data relating to location, type and fluid flow within the additional completion hardware configurations and the reservoir into the main program; and
code that, when executed by the processor, is adapted to assess an impact on depletion of hydrocarbon resources in the reservoir based on the different completion hardware configurations.

17. A method for producing hydrocarbons from an oil and/or gas field using a visualization representing location, type and fluid flow in a completion hardware configuration and the fluid flow in a reservoir in the oil and/or gas field, the reservoir containing the completion hardware configuration, the method comprising:
obtaining data relating to a location and type of the completion hardware configuration;
obtaining data relating to fluid flow within the completion hardware configuration based on the location and type of the completion hardware;
obtaining data relating to fluid flow within the reservoir;
importing the data relating to the location and type of the completion hardware configuration and the fluid flow within the completion hardware configuration into a main program;
importing the data relating to fluid flow within the reservoir into the main program;
providing a visualization that includes the data relating to the location and type of the completion hardware configuration and the fluid flow within the completion hardware configuration, along with the data relating to fluid flow within the reservoir; and
extracting hydrocarbons from the oil and/or gas field based on the visualization.

18. The method recited in claim 17, comprising taking into account a difference in format of the data relating to fluid flow within the completion hardware configuration relative to the data relating to fluid flow within the reservoir when providing the visualization.

19. The method recited in claim 18, wherein the difference in format includes that the data relating to fluid flow within the completion hardware configuration includes a relatively large number of data elements per unit length or volume relative to the data relating to the fluid flow within the reservoir.

20. The method recited in claim 18, wherein taking into account comprises normalizing the difference in format.
